(19) United States
(12) Patent Application Publication
(10) Pub. No.: US 2024/0396850 A1
(43) Pub. Date: Nov. 28, 2024

(54) COMMUNICATION DEVICE, COMMUNICATION METHOD, AND STORAGE MEDIUM

(71) Applicant: DENSO CORPORATION, Kariya-city (JP)

(72) Inventor: Satoshi YOSHINAGA, Kariya-city (JP)

(21) Appl. No.: 18/792,373

(22) Filed: Aug. 1, 2024

Related U.S. Application Data
(63) Continuation of application No. PCT/JP2022/042851, filed on Nov. 18, 2022.

(30) Foreign Application Priority Data
Feb. 3, 2022 (JP) 2022-015863

(51) Int. Cl. H04L 47/32; H04L 49/90; H04L 69/22

(52) U.S. Cl. CPC H04L 47/32; H04L 49/9042; H04L 69/22; H04L 2212/00

(57) ABSTRACT

The communication device has a receiver that receives packets from the first device, a packet identifier that identifies the chunk, which is a data unit in a higher layer, to which said packet belongs, a buffer that stores said packet, and a buffer control unit that reads the packet from the buffer and sends it to the second device as a unit of the chunk. The buffer control unit controls the storing of said packets in said buffer and the discarding of the packets from said buffer, and the transmitter reads the packets from the buffer and transmits them to the second device.

### CROSS-REFERENCE TO RELATED APPLICATION

The present application is a continuation application of International Application No. PCT/JP2022/042851, filed on Nov. 18, 2022, which claims priority to Japanese Patent Application No. 2022-015863, filed on Feb. 3, 2022. The contents of these applications are incorporated herein by reference in their entirety.

### BACKGROUND

### 1. Technical Field

This application relates to a communication device having a buffer to store received packets, a communication method, and a storage medium.

### 2. Related Art

When a communication device receives packets, it stores the received packets in a buffer and reads packets from the buffer for transmission. However, due to the capacity of the buffer, it is necessary to control the storage of received packets in the buffer and the discarding of packets from the buffer.

### SUMMARY

A communication device according to an aspect of the present disclosure transmits packets received from a first device to a second device using one of a plurality of communication lines. The device has: a receiver that receives packets from the first device, a packet identification unit that identifies a chunk, which is a data unit in upper layers, to which the packets belong, a buffer that stores the packets, a buffer control unit that controls storing the packets into the buffer and discarding the packets from the buffer based on the chunk to which the packets belong, and a transmitter that reads the packets from the buffer and transmits the read packets to a second device. The buffer control unit discards, based on whether a first packet received by the receiver can be stored into the buffer and based on the chunk to which the first packet belongs, a second packet which is a stored packet in the buffer and other packets in the buffer, the second packet and the other packets belonging to the first chunk or a second chunk.

A communication method according to another aspect of the present disclosure is performed using a communication device that transmits packets received from a first device to a second device using one of a plurality of communication lines. The method includes: receiving packets from the first device, identifying a chunk, which is a data unit in upper layers, to which the packets belong, controlling storing the packets into a buffer and discarding the packets from the buffer based on the chunk to which the packets belong, and reading the packets from the buffer and transmitting the read packets to a second device. The controlling includes discarding, based on whether a first packet received by the receiver can be stored into the buffer and based on the chunk to which the first packet belongs, a second packet which is a stored packet in the buffer and other packets in the buffer, the second packet and the other packets belonging to the first chunk or a second chunk.

A computer-readable non-transitory storage medium according to another aspect of the present disclosure stores a program. The program causes a communication device that transmits packets received from a first device to a second device using one of a plurality of communication lines to: receive packets from the first device, identify a chunk, which is a data unit in upper layers, to which the packets belong, control storing the packets into a buffer and discarding the packets from the buffer based on the chunk to which the packets belong, and read the packets from the buffer and transmit the read packets to a second device. The controlling includes discarding, based on whether a first packet received by the receiver can be stored into the buffer and based on the chunk to which the first packet belongs, a second packet which is a stored packet in the buffer and other packets in the buffer, the second packet and the other packets belonging to the first chunk or a second chunk.

### BRIEF DESCRIPTION OF THE DRAWINGS

FIG. 1 shows the configuration of the communication device of the first embodiment,

FIG. 2 shows the packet information stored in the packet information storage of the communication device of the first embodiment,

FIG. 3 shows a specific example of operation of the packet identification unit of the communication device of the first embodiment,

FIG. 4 shows another specific operation example of the packet identification unit of the communication device of the first embodiment,

FIG. 5 shows another specific example of operation of the packet identification unit of the communication device of the first embodiment,

FIG. 6 shows a specific example of operation of the buffer control unit of the communication device of the first embodiment,

FIG. 7 shows another specific example of operation of the buffer control unit of the communication device of the first embodiment,

FIG. 8 shows another specific example of operation of the buffer control unit of the communication device of the first embodiment,

FIG. 9 is a flowchart showing the operation of the communication device of the first embodiment,

FIG. 10 shows the configuration of the communication device in the second embodiment,

FIG. 11 shows a specific example of operation of the packet identification unit of the communication device in the second embodiment,

FIG. 12 shows the packet information stored in the packet information storage of the communication device in the second embodiment,

FIG. 13 shows a specific example of a combination of a source device, a communication device of the first embodiment or the second embodiment, and a destination device.

### DETAILED DESCRIPTION OF THE PREFERRED EMBODIMENTS

JP2003-179633A discloses that a queue temporarily stores transmitted packets, and (1) when the queue length, which is the sum of packet lengths entering the queue, is less than a predetermined threshold value packets are sequentially queued, and (2) when the queue length is greater than the predetermined threshold value, the packet is discarded depending on the packet discard level and the position of the queue to be stored is changed.

JP2006-115197A states that packets are discarded if the queue length is greater than the maximum queue length.

Here, the inventor has found the following issues as a result of detailed study. When storing data into or discarding data from a buffer on a packet-by-packet basis, as in JP2003-179633A and JP2006-115197A, there is a possibility that data needed by the upper layers may be missing. In such cases, the transmitted data may not be available, which hinders efficient data transmission.

The purpose of this disclosure is to realize a communication device, etc. that can perform efficient data transmission by reducing the possibility of data loss occurrence.

With the configuration described above, the communication devices and other devices of the present disclosure can reduce the possibility of data loss occurrence and perform efficient data transmission.

Embodiments of the present disclosure are described below with reference to the drawings.

The present invention means the invention described in the claims and is not limited to the following embodiments. Words and phrases in double quotation marks refer to the words and phrases described in the claims, and likewise are not limited to the following embodiments.

The configurations and methods described in the dependent claims are optional configurations and methods of the invention described in the independent claims. Configurations and methods of embodiments corresponding to the configurations and methods described in the dependent claims, as well as configurations and methods not described in the claims but only in the embodiments, are optional configurations and methods of the present invention. The configurations and methods described in the embodiments in cases where the claims are broader than the description of the embodiments are also optional configurations and methods in the present invention in the sense that they are examples of the configurations and methods of the invention. In either case, the description in the independent claims is an essential configuration and method of the invention.

The effects described in the embodiments are those of having the configuration of the embodiments as an example of the invention and not necessarily those of the invention.

If there are multiple embodiments (including variations), the configuration disclosed in each embodiment is not limited to the embodiment only but can be combined across embodiments. For example, the configuration disclosed in one embodiment can be combined with other embodiments. Also, configurations disclosed in each of multiple embodiments can be partially collected and combined.

The problems described in this disclosure are not publicly known but were independently discovered by the inventor. The problems described in this disclosure affirm the inventive step of the invention together with the composition and method described in this disclosure.

### 1. First Embodiment

### (1) Overall Configuration of Communication Device 100

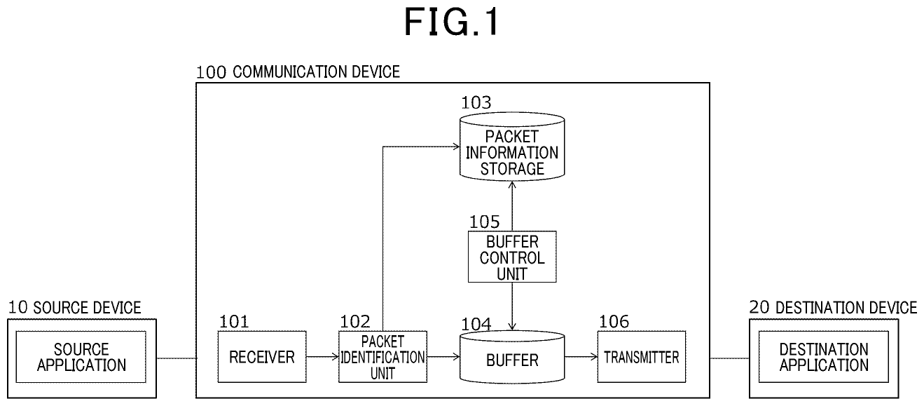

FIG. 1 illustrates the configuration of the communication device 100 of the first embodiment. The communication device 100 has a receiver 101, a packet identification unit 102, a packet information storage 103, a buffer 104, a buffer control unit 105, and a transmitter 106.

The communication device 100 can be configured with a general-purpose CPU (Central Processing Unit), volatile memory such as RAM, ROM, flash memory, or nonvolatile memory such as a hard disk, various interfaces, and an internal bus connecting them. Then, by executing software on this hardware, it can be configured to perform the functions of each functional block described in FIG. 1. Of course, the communication device 100 may be realized by dedicated hardware such as an LSI. The above description is also true for other forms of communication devices.

The communication device 100 is an electronic control unit (ECU (Electronic Control Unit), hereinafter abbreviated as ECU) as a semi-finished product in this embodiment. However, it is not limited to this form. For example, semiconductor circuits and semiconductor modules are assumed in the form of components, electronic control units, electronic control units, and system boards in the form of semi-finished products, and servers, workstations, personal computers (PCs), tablets, mobile routers, smart phones, cell phones, and navigation systems in the form of finished products. phones, and navigation systems. The communication device 100 may consist of multiple ECUs as well as a single ECU. The above description is also true for other forms of communication devices.

Receiver 101 receives “packets” generated by the source device 10 (an example of the “first device”) from the source device 10. The packets are, for example, data generated by the transmission source application running in the transmission source device 10, divided into multiple packets by packetization or fragmentation performed by the control unit or other unit not shown in the figure of the transmission source device 10, and then transmitted. The term “packet” refers to a mass of data as transmitted data, in information communication, can be called by any name, such as frame, segment, etc., in addition to “packet” in a narrow sense.

The source application generates data. A video transmission application is an example of the source application. The video transmission application compresses image data captured by a camera connected to the source device 10 into I-frame, P-frame, and B-frame data based on, for example, the H.264/MPEG4 AVC standard and transmits it to a destination application in the destination device 20. destination In this case, each compressed frame data is fragmented by the network card (NIC: Network Interface Card) of the source device 10 to be divided into packets of the MTU (Maximum Transmitter) size of the NIC and transmitted. The packets are then sent.

The source device 10 and the communication device 100 are connected via communication path. Communication path may be either wireless or wired communication path. Examples of wireless communication path include communication path based on mobile communication systems, such as W-CDMA (Wideband Code Division Multiple Access), HSPA (High Speed Packet Access), LTE (Long Term Evolution (W-CDMA), HSPA (High Speed Packet Access), LTE (Long Term Evolution), LTE-A (Long Term Evolution Advanced), 4G, or 5G wireless communication systems can be used. In addition, wireless communication path consisting of wireless communication methods such as IEEE802.11 (Wi-Fi (registered trademark)), IEEE802.16 (WiMAX (registered trademark)), Bluetooth (registered trademark), UWB (Ultra-Wide Band), or DSRC (Dedicated Short Range Communication paths consisting of wireless communication methods such as IEEE 802.16 (Wi-Fi (registered trademark)), Bluetooth (registered trademark), UWB (Ultra-Wide Band), or DSRC (Dedicated Short Range Communication) can also be used. As examples of wired communication path, LAN (Local Area Network) such as Ethernet (registered trademark), optical fibers, or fixed telephone lines can be used. In the case of in-vehicle device, for example, CAN (Controller Area Network) or LIN (Local Interconnect Network), which is an in-vehicle network, can be used. In addition, the communication path may be a combination of wireless and wired communication path.

The form of the transmission source device 10 may be a component, a semi-finished product, or a finished product, as well as the communication device 100. The specific form of the transmission source device 10 is described below.

The packet identification unit 102 obtains packet information by analyzing packets received by the receiver 101 and stores the obtained packet information in the packet information storage 103. Also, the packet identification unit 102 identifies the chunk to which the packet received by the receiver 101 belongs. A chunk is a data unit that is treated as a single piece of data in the higher layers. Higher layers are layers which are the transport layer (Layer 4) or above the transport layer when packets are communicated in network layer (Layer 3) of the OSI reference model. An example of a chunk is compressed frame data (I-frames, P-frames, or B-frames) when the source application of the transmitting terminal device 10 is a video transmission application.

In addition to this, the packet identification unit 102 obtains packet size, chunk size, and importance information of received packets by analyzing the packets. The specific chunk identification and chunk numbering methods performed by the packet identification unit 102 are described below.

The packet information storage 103 stores packet information obtained by the packet identification unit 102. For example, the packet information storage 103 stores packet information input from the packet identification unit 102 in the order of input. The packet information storage 103 may have either nonvolatile memory or volatile memory.

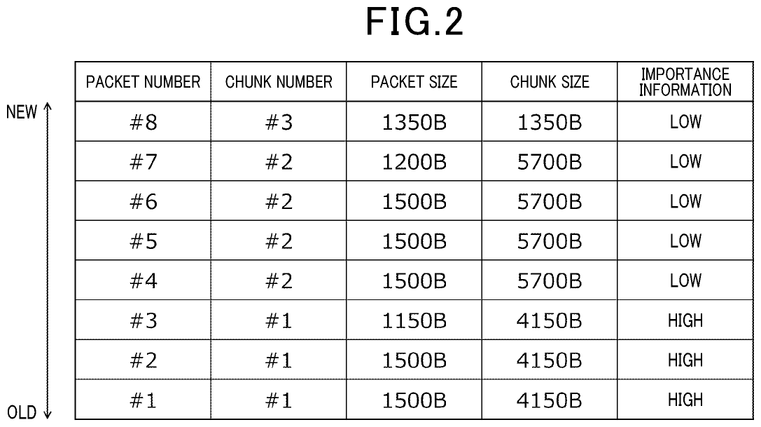

FIG. 2 shows packet information stored in the packet information storage 103. The packet number is a serial number assigned by the packet identification unit 102 for each packet received by the receiver 101 in the order received by the receiver 101.

The chunk number is a serial number that identifies the chunk to which each packet belongs. The chunk number is assigned by the packet identification unit 102 by analyzing each packet received by the receiver 101.

The packet size is the packet size obtained by the packet identification unit 102 for each packet received by the receiver 101. In a case that the packet size is listed in the IP header or other identification information, the identification information should be recorded. In the case of fixed-length packets, it is sufficient to record the predetermined fixed-length packet size.

The chunk size is the size of the chunk identified by the packet identification unit 102. The chunk size can be obtained, for example, by summing the packet sizes of packets assigned the same chunk number. Specifically, the chunk size is obtained as follows.

In the example in FIG. 2, when packet #1 (chunk number #1) is received, there is still only one packet with chunk number #1, so 1500B, the same as the packet size, is recorded for the chunk size of packet #1. When packet #2 (chunk number #1) is next received, there will be two packets with chunk number #1, so the chunk size of packet #1 and packet #2 will be recorded as 3000B, which is the earlier chunk size of 1500B plus the packet size of packet #2. Furthermore, when packet #3 (chunk number #1) is received, there will be three packets with chunk number #1, so the chunk size of packet #1 through packet #3 will be recorded as 4150B, adding the packet size of packet #3 (1150B) to the earlier chunk size of 3000B. When packet #4 (chunk number #2) is received, the chunk number of packet #4 is different from the chunk numbers of packets #1 through #3 received earlier, so 1500B, the same as the packet size, is recorded for the chunk size of packet #4. Hereafter, the chunk size is recorded for each packet input by the same calculation.

The importance information is information indicating the importance of the packet. Specifically, the importance information is information assigned to each packet by the source device 10 or information assigned by the packet identification unit 102 by analyzing the packet based on the contents of the payload data of the packet. The importance of a packet may be defined according to the purpose of the source application or the purpose of the installation of the communication device 100. For example, in a case that the packet is video image data, the importance of packets including I-frames may be raised above the importance of packets including other types of frames because missing I-frames would prevent decoding of P-frames and B-frames. Alternatively, in a case that the communication device 100 is an in-vehicle device installed in an automobile, the importance of information directly indicating the driving status, such as speed and acceleration, may be raised above the importance of other information. In FIG. 2, the importance information is shown as two values (“High” or “Low”), but the importance information may be defined in three or more levels.

The packet information stored in the packet information storage 103 may be updated according to the processing status of packets stored in the buffer 104 described below. For example, when a packet is stored in the buffer 104, the packet information of the stored packet is recorded in the packet information storage 103. When a packet is discarded from the buffer 104, the packet information of the discarded packet is deleted from the packet information storage 103. When the transmitter 107 reads a packet from the buffer 104 and transmits it, the packet information of the read packet is deleted from the packet information storage 103.

The buffer 104 stores packets received by receiver 101 and whose chunks are identified by packet identifier 102. Specifically, the buffer 104 stores packets received by receiver 101 in the order of receipt, excluding those that are discarded. Like the packet information storage 103, the buffer 104 may be composed of either nonvolatile memory or volatile memory. The buffer 104 is an area for storing packets, and the packets in the buffer 104 may be stored or read in an arbitrary order. The buffer 104 may include a queue and/or a stack.

In this implementation, the buffer 104 is controlled based on FIFO (First In First Out) operation, which stores the packets in input order and outputs packets in the input order, and may be referred to as a queue. However, in this implementation, the output order may not necessarily be the input order.

The buffer control unit 105 controls the storing of packets into buffer 104 and the discarding of packets from buffer 104. Specifically, the buffer control unit 105 controls the storing and discarding of packets “based on the chunk to which the packets belong” on the basis of the packet information stored in the packet information storage 103. Here, “based on the chunk to which the packets belong” means that storing to and discarding from a buffer should result in a unit of the chunk, and it is not necessary to store all packets belonging to the same chunk at the same time when storing to a buffer, nor is it necessary to discard all packets belonging to the same chunk at the same time when discarding from a buffer. When storing to a buffer, it is not necessary to store all packets belonging to the same chunk at the same time.

The specific methods of storing and discarding packets performed by the buffer control unit 105 are described below.

The transmitter 106 reads packets from the buffer 104 and transmits them to the destination device 20 (an example of the “second device”). The order in which packets are read is in principle the same as the input order of buffer 104, but in this implementation, it may not necessarily be the input order. The transmitted packets are used by the destination application in the destination device 20.

The destination application uses the data contained in the packet. For example, the destination application may be image playback software that decodes and plays back compressed image data.

The communication device 100 and the destination device 20 are connected via communication path. The communication path may be either a wireless communication path or a wired communication path. The examples of wireless communication path and wired communication path are the same as those described as examples of communication path between the transmission source device 10 and the communication device 100. The same applies to the fact that the communication path may be a combination of a wireless communication path and a wired communication path. For example, if the destination device 20 is a server device connected to the Internet, a 4G or 5G wireless communication system can be used between the communication device 100 and the base station device, and a wired communication system consisting of an optical line between the base station device and the destination device 20.

The form of the destination device 20 may be a component, semi-finished product, or finished product, as with the communication device 100. The specific form of the destination device 20 is described below.

(2) Details of the Packet Identification Unit 102 of the Communication Device 100 of this Embodiment

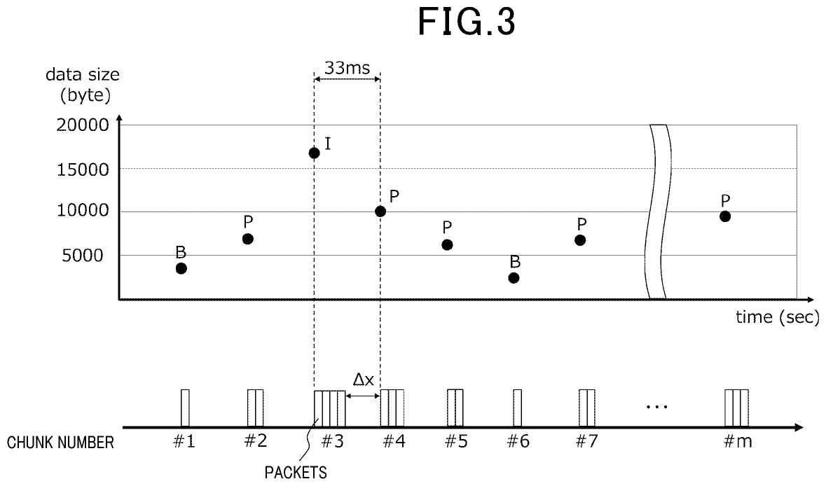

Each of FIGS. 3-5 illustrates examples of specific chunk identification and chunk numbering methods performed by the packet identification unit 102.

### (a) An Example of Identification of Chunks Based on the Interval of Packet Reception

FIG. 3 illustrates an example of identifying chunks based on the interval of packet reception. In this example, the packet identification unit 102 identifies chunks based on the reception interval of packets received by the receiver 101.

When the video transmission application of the transmitting terminal device 10 compresses images and transmits frames, the transmitting terminal device 10 divides each frame into single or multiple packets and transmits the frames as shown in FIG. 3. If the frame rate is 30 FPS (Frames Per Second), each frame is divided into multiple packets and transmitted by frame every 1/30 s=33 ms. Since the packets in a single frame are continuously transmitted in bursts, the transmission interval between packets is very small. In contrast, in case of spanning frames, the time between the transmission of the last packet in the previous frame and the transmission of the first packet in the next frame (Δx) is some wide transmission interval. On the other hand, since the amount of data in an I-frame is larger than that in a P- or B-frame, the transmission interval between an I-frame and another frame or a sequence of I-frames is smaller.

The packet identification unit 102 uses, for example, 5 ms as a threshold to enable correct determination even when I-frames are consecutive. If Δx is smaller than 5 ms, the packets are determined to belong to the same frame, and if Δx is greater than or equal to 5 ms, the packets are determined to belong to different frames. Each frame is then identified as one chunk, and packets belonging to the same chunk are assigned the same chunk number, and when the new chunk is started, the chunk number is assigned incrementally. In the example in FIG. 3, the packet identification unit 102 assigns #1, #2, . . . #m as the chunk number in the order of reception. Based on the chunk number, it is possible to identify which chunk the packet belongs to.

In the example in FIG. 3, video compression using the H.264/MPEG4 AVC standard is used as an example, but the same applies when still image compression (e.g., JPEG standard) is used.

### (b) An Example of Identifying Chunks Based on the IP Header of a Packet

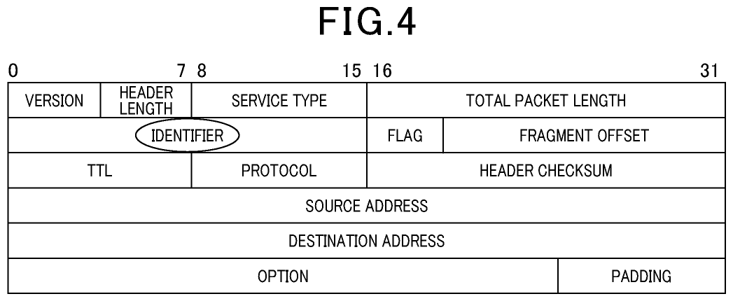

FIG. 4 illustrates an example of the IP header. In this example, the packet identification unit 102 identifies chunks based on the identifier in the IP header of the packet.

The IP header shown by FIG. 4 contains information about the packet. For example, in a case that the source device 10 attempts to send a large frame data in a single packet, NIC performs fragmentation of the frame data, and the frame data is divided into multiple packets. In this case, the IP header of each packet originating from the same frame is assigned the same identifier. When a frame transmitted by the source terminal device 10 is defined as a chunk, the packet identification unit 102 can identify which chunk the packet belongs to, based on the identifier in the IP header. In this implementation, the packet identification unit 102 assigns the same chunk number to the packets which have the same IP header identifier and increment the chunk number when the IP header identifier has changed.

### (c) An Example of Identification of Chunks Based on Packet Payload Data

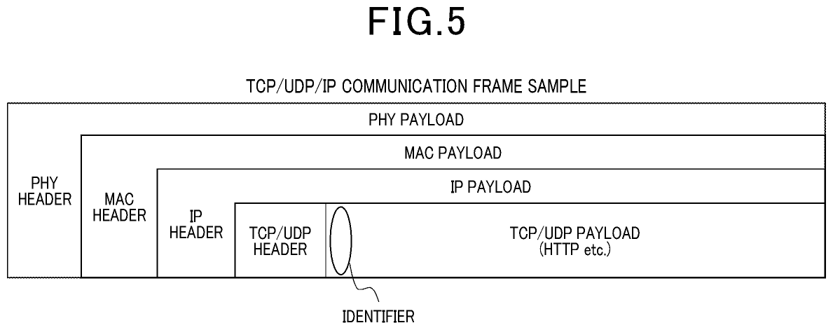

FIG. 5 illustrates an example of the TCP/UDP payload of the packet. In this example, the packet identification unit 102 identifies chunks based on the identification information contained in the TCP/UDP payload of the packet.

When large size data is packetized into small size packets by the source application, the source application stores identification information indicating the data before splitting at the beginning of the TCP/UDP payload. When data transmitted by the source terminal device 10 is defined as a chunk, the packet identification unit 102 can identify which chunk the packet belongs to, based on the identification information in the TCP/UDP payload. In this implementation, the packet identification unit 102 increments and assigns a chunk number to each TCP/UDP payload identification information.

### (d) Other Example of Identification of Chunks

The packet identification unit 102 may identify chunks from the timestamp when they are stored in the buffer 104. In a case that video compression is used, and I-frame, P-frame, and B-frame information is recorded in the packet, the packet identification unit 102 may identify chunks based on this information.

(3) Details of the Buffer Control Unit 105 of the Communication Device 100 of this Embodiment

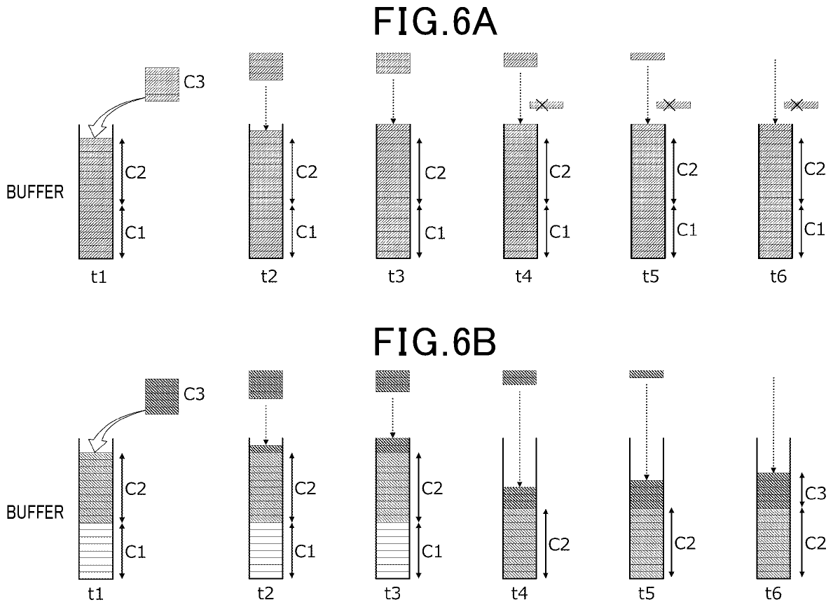

Examples of specific packet storing and discarding methods performed by the buffer control unit 105 are described in FIGS. 6-8.

### (a) Example of Storing New Chunks and Discarding Old Chunks (Example 1)

FIG. 6 illustrates an example of storing packets belonging to new chunks in buffer 104 and discarding packets belonging to old chunks from buffer 104. In this example, when a newly arrived packet cannot be stored in buffer 104 due to exceeding the capacity of buffer 104, buffer control unit 105 discards stored packets from buffer 104 that belong to another chunk different from the chunk to which the newly arrived packet belongs.

FIG. 6A shows an example of storing and discarding packets in the conventional example. Although packets are not conventionally stored and discarded in the perspective of chunks, the term “chunk” is used in the conventional example to explain the effect in this implementation in comparison with the current implementation.

At time t1, packets corresponding to chunk 1 (C1 in the drawing: the same below) and chunk 2 are already stored in buffer 104. Then, assume the case where five packets corresponding to chunk 3 are newly stored in buffer 104.

At times t2 and t3, packets corresponding to chunk 3 are sequentially stored in the free space of buffer 104. However, at time t4, the capacity of buffer 104 is saturated, and the third packet in chunk 3 cannot be stored in buffer 104 and is discarded. Similarly, at times t5 and t6, the fourth and fifth packets are discarded.

Eventually, at time t6, some packets corresponding to chunk 3 are discarded, and all packets corresponding to chunk 3 are no longer aligned. As a result, even if packets corresponding to chunk 3 remaining in buffer 104 are sent to destination device 20, they cannot be used by the destination application of destination device 20, and packets belonging to chunk 3 are wasted, resulting in inefficient data transmission.

FIG. 6B shows an example of storing and discarding packets in this example. In this example, the process from time t1 to t3 is the same as in the conventional example, but when packets cannot be stored in buffer 104 at time t4 because they exceed the capacity of buffer 104, packets belonging to chunk 1 or chunk 2, which are chunks different from chunk 3, and already stored in buffer 104 (example of “already stored packets”) are discarded from buffer 104. In the case of FIG. 6B, packets belonging to chunk 1, which were stored in buffer 104 earliest in time, are discarded. As a result, the third packet in chunk 3 is also stored in buffer 104. Similarly at times t5 and t6, the fourth and fifth packets are also stored in buffer 104.

At time t6, all packets belonging to chunk 1 are discarded, but packets belonging to chunks 2 and 3 are stored. As a result, packets that cannot be used by the destination application of the destination device 20 are not sent, and efficient data transmission can be performed. Moreover, the packets that are not sent to the destination device 20 as a result are packets that belong to a chunk that is older in time in this example than in the previous example, so data that is closer to the present than can be used. This is especially effective when the destination application is an application that requires real-time performance.

In FIG. 6, in a case that some of the packets belonging to chunk 1 have already been read from the transmitter 106 at time t4 and have already been transmitted, the buffer control unit 105 may not discard packets belonging to chunk 1 but discard packets belonging to chunk 2. According to this process, packets that have already been transmitted will not be wasted. Similarly, when the importance of chunk 1 is higher than that of chunk 2, packets belonging to chunk 1 may not be discarded and packets belonging to chunk 2 may be discarded. The same is true in Example 2 below.

Alternatively, when the number of packets belonging to chunk 1 remaining in buffer 104 at time t4 (example of “stored packets”) exceeds the “predetermined ratio” of all packets belonging to chunk 1, including packets belonging to chunk 1 that have already been transmitted, the packets belonging to chunk 1 remaining in buffer 104 may be discarded from buffer 104. If the packets belonging to chunk 1 remaining in buffer 104 “exceed” the “predetermined ratio,” the packets belonging to chunk 1 remaining in buffer 104 may be discarded from buffer 104. The predetermined ratio can be set to 1/2, 2/3, or 3/4, for example. According to this process, the waste of communication resources can be minimized, and minimum real-time performance can be maintained. The same is true for Example 2 described below. The “predetermined ratio” may be a predetermined fixed value or a variable value that varies according to conditions. “Exceeds” may include a predetermined ratio, i.e., it may be greater than or equal to a predetermined ratio.

As in the example of FIG. 6B, when some packets belonging to a chunk are discarded from buffer 104, the discarded packets are naturally not transmitted from transmitter 106, but if they have already been read from buffer 104 but have not yet been transmitted, the transmitter 106 may stop transmitting.

At time t4 in this example, the packets belonging to chunk 1, which were stored in buffer 104 earliest in time, were discarded, but buffer control unit 105 may not discard packets belonging to chunk 1 from buffer 104 in a case that the importance of the packets belonging to chunk 1 exceeds a “predetermined level”. In that case, the next packets belonging to chunk 2 that are stored in buffer 104 earlier in time may be discarded. Whether or not the importance level exceeds the predetermined importance level can be determined based on the importance level information recorded in the packet information storage 103, as shown in FIG. 2. The same is true in Example 2 described below. However, the buffer control unit 105 may discard packets belonging to chunk 1 from buffer 104 in a case that packets belonging to newly stored chunk 3 exceed a predetermined importance level, even if packets belonging to chunk 1 exceed the predetermined importance level. The “predetermined level of importance” can be a predetermined value or can vary depending on the conditions. “Exceeding” may include a predetermined level of importance, i.e., it may be greater than or equal to a predetermined level of importance.

### (b) Example of Storing New Chunks and Discarding Old Chunks (Example 2)

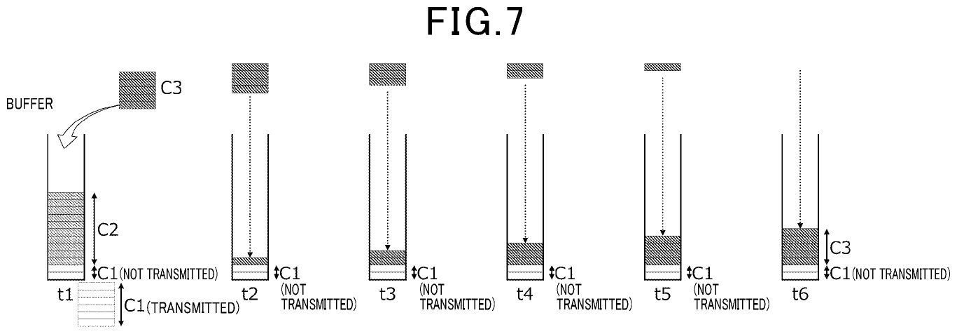

FIG. 7 illustrates another example where packets belonging to new chunks are stored in buffer 104 and packets belonging to old chunks are discarded from buffer 104. In Example 1, stored packets belonging to old chunks were discarded from buffer 104 due to exceeding the capacity of buffer 104. In this example, stored packets belonging to old chunks are discarded from buffer 104 because new chunks are stored in buffer 104.

In this example, when a packet is stored in buffer 104, buffer control unit 105 discards from buffer 104 the stored packets that belong to other chunks different from the chunk to which this packet belongs and were stored in buffer 104 before this packet.

FIG. 7 shows an example of storing and discarding packets in this example. At time t1, packets belonging to chunks 1 and 2 respectively are already stored in buffer 104, and some packets for chunk 1 have already been transmitted. Then, assume the case where five packets belonging to chunk 3 are newly stored in buffer 104.

At time t2, packets belonging to chunk 3 are stored in the free area of buffer 104. In this case, packets belonging to chunk 1 or 2, which are different chunks from chunk 3 and stored in buffer 104 (example of “stored packets”), are discarded from buffer 104. In the case of FIG. 7, packets belonging to chunk 2, which is the chunk in which more than a predetermined rate of packets remain in buffer 104 and which was stored in buffer 104 the earliest in time, are discarded.

From time t3 to t6, the second through fifth packets are sequentially stored in buffer 104.

At time t6, all packets belonging to chunk 2 are discarded, but unsent packets in chunk 1 and packets belonging to chunk 3 are stored. As a result, packets that cannot be used by the destination application on the destination device 20 are not sent, and efficient data transmission can be performed. Moreover, the packets that are not sent to the destination device 20 as a result are packets that belong to a chunk that is older in time in this example than in the conventional example, which means that data closer to the present can be used. This is particularly effective when the destination application is an application for which real-time performance is important.

### (c) Example of Discarding New Chunks and Keeping Old Chunks (Example 3)

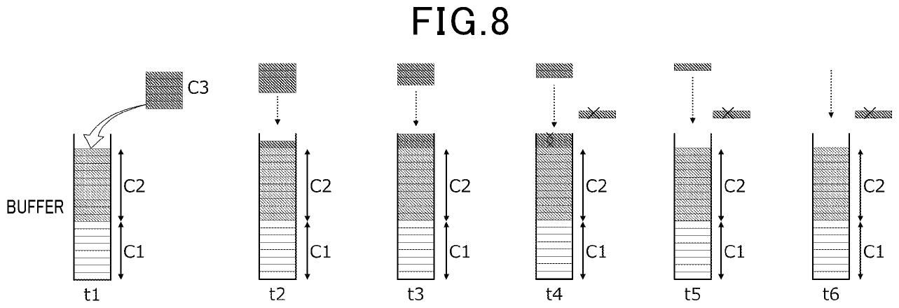

FIG. 8 illustrates an example of discarding packets belonging to new chunks from buffer 104 and leaving packets belonging to old chunks in buffer 104. In Example 1, stored packets belonging to old chunks were discarded from buffer 104 due to exceeding the capacity of buffer 104. In this example, stored packets belonging to a new chunk are discarded from buffer 104 because the capacity of buffer 104 is exceeded.

In this example, when a newly added packet cannot be stored in buffer 104 due to exceeding the capacity of buffer 104, buffer control unit 105 discards from buffer 104 the stored packets that belong to the same chunk as this packet and were stored in buffer 104 before this packet.

FIG. 8 shows an example of storing and discarding packets in this example. At time t1, packets belonging to chunks 1 and 2 are already stored in buffer 104. Then, assume the case where five packets belonging to chunk 3 are newly stored in buffer 104.

At times t2 and t3, packets belonging to chunk 3 are sequentially stored in the free area of buffer 104. However, at time t4, the capacity of buffer 104 is saturated, and the third packet of chunk 3 cannot be stored in buffer 104 and is discarded. In this case, packets belonging to chunk 3, which is the same chunk as chunk 3 and already stored in buffer 104 (an example of “already stored packets”), are discarded from buffer 104. In the case of FIG. 7, the first and second stored packets belonging to chunk 3 are discarded at time t4.

At times t5 and t6, packets belonging to chunk 3 are still discarded without being stored in buffer 104.

At time t6, all packets belonging to chunk 3 are discarded, but packets belonging to chunks 1 and 2 are stored. As a result, packets that cannot be used by the destination application in the destination device 20 are not sent, and efficient data transmission can be performed. Moreover, the packets that are not sent to the destination device 20 as a result are packets that belong to a new chunk, so the data that maintains the time series can be used. This is particularly effective when the destination application is an application that requires time-series data to be played back in sequence, such as viewing video content.

When packets belonging to chunk 1 and chunk 2 are sequentially transmitted to the destination device 20 and there is room in the buffer 104, a retransmission request can be made from the communication device 100 to the source device 10 to receive packets belonging to chunk 3 again from the source device 10. The packets belonging to chunk 3 can be received again from the source device 10 and sent to the destination device 20 by making a retransmission request from the communication device 100 to the destination device 20.

(4) Operation of Communication Device 100 of this Embodiment

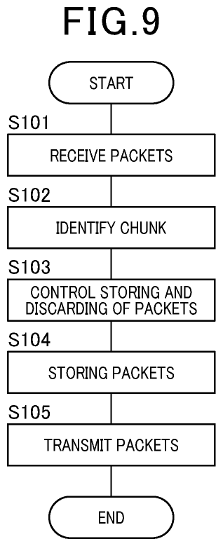

FIG. 9 illustrates the operation of communication device 100 of this embodiment. The following operations not only show the communication method in the communication device 100, but also the processing steps of the communication program executed in the communication device 100. Also, these processes are not limited to the order shown in FIG. 9. In other words, the order may be interchanged as long as there are no restrictions, such as a relationship in which one step uses the results of the preceding step in a certain step. The above is true not only in this embodiment, but also in other embodiments.

The receiver 101 of the communication device 100 receives a “packet” generated by the source device 10 (S101). The packet identification unit 102 of the communication device 100 identifies the chunk to which the packet received by the receiver 101 belongs (S102). The buffer control unit 105 of the communication device 100 controls the storing and discarding of packets “based on the chunk to which the packets belong” on the basis of the packet information stored in the packet information storage 103 (S103). Buffer 104 of communication device 100 stores packets received by receiver 101 according to the result of control by buffer control unit 105 (S104). The transmitter 106 of the communication device 100 reads the packet from the buffer 104 and transmits it to the destination device 20 (S105).

According to this embodiment, by controlling the storing and discarding of packets into the buffer in units of chunks, which are data units in the upper layers, it is possible to reduce the risk of missing data and enable efficient data transmission.

### 2. Second Embodiment

(1) Overall Configuration of this Communication Device 200

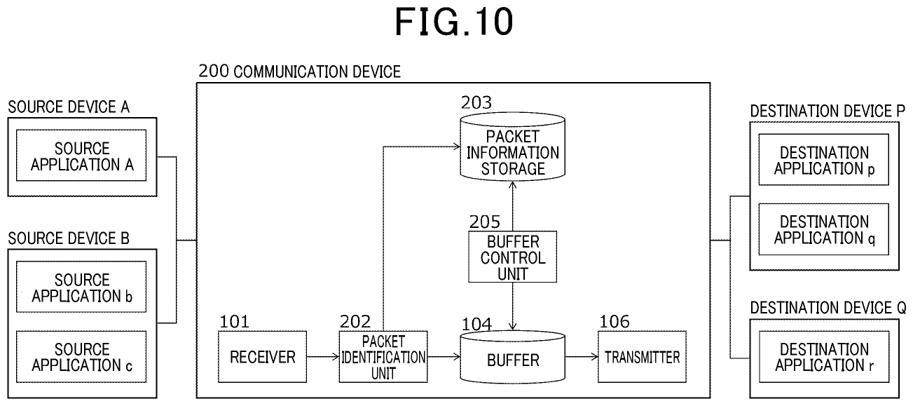

In the first embodiment, chunk identification was performed without distinguishing between connected source device 10 and destination device 20, or between the source and destination applications installed in the respective device. However, when multiple source terminal devices 10 and destination devices 20 are connected, it is necessary to treat each chunk as a different chunk even if they use the same software. Also, if multiple source applications or multiple destination applications are running on the source terminal device 10 or destination device 20, it is necessary to distinguish chunks for each application. The case of multiple connected source terminal devices 10 and destination devices 20, or multiple source and destination applications on each device, is explained in the second embodiment referencing FIG. 10. The same reference numerals as in FIG. 1 are used for the same functions as those in the first embodiment, and the explanation of the first embodiment is referred to.

FIG. 10 illustrates the configuration of the communication device 200 in the second embodiment. The communication device 200 has a receiver 101, a packet identification unit 202, a packet information storage 203, a buffer 104, a buffer control unit 205, and a transmitter 106.

A source terminal device A and a source terminal device B, which are multiple source terminal devices, are connected to the communication device 200. Also, multiple destination devices, destination device P and destination device Q, are connected to the communication device 200. The source terminal device A is equipped with and executes the source application a. The source terminal device B is equipped with and executes the source application b and the source application c. The destination device P is equipped with and executes the destination application p and the destination application q. The destination device P is equipped with and executes the destination application p and the destination application q. The destination device Q is equipped with and executes the destination application r. Three or more source and destination devices may be connected. Three or more source and destination applications may also be installed and executed on a single device.

In addition to identifying chunks as described in the first embodiment, the packet identification unit 202 further identifies the communication flow to which the packet belongs based on the source and/or destination of the packet.

A communication flow can include, for example, information identifying the source and the destination. For example, if a packet is sent from source application a of source terminal device A to destination application q of destination device P, the communication flow can be expressed as AaPq.

If only one source terminal device is connected to the communication device 200, information identifying the source terminal device can be omitted. If only one destination device is connected to the communication device 200, information identifying the destination device can be omitted. For example, if the only a source terminal device B is connected to communication device 200 as the source terminal device, the communication flow can be expressed as bPq when a packet is sent from source application b in source terminal device B to destination application q in destination device P. If only one source application is installed in the source device or one destination application is installed in the destination device, the information identifying the source or destination application can be omitted. For example, if the only source terminal device A is connected to communication device 200 as the source terminal device, and the only source application a is installed in source terminal device A as the source application, the communication flow can be expressed as Pq when a packet is sent from source application a in source terminal device A to destination application q in destination device P.

To identify the source and destination, information stored in the IP header and TCP/UDP header can be used.

As shown in FIG. 4, the source and destination addresses are stored in the IP header, so the source and destination devices can be identified based on these addresses. In addition, since the IP header contains the protocol, the source and destination applications can be identified based on the protocol.

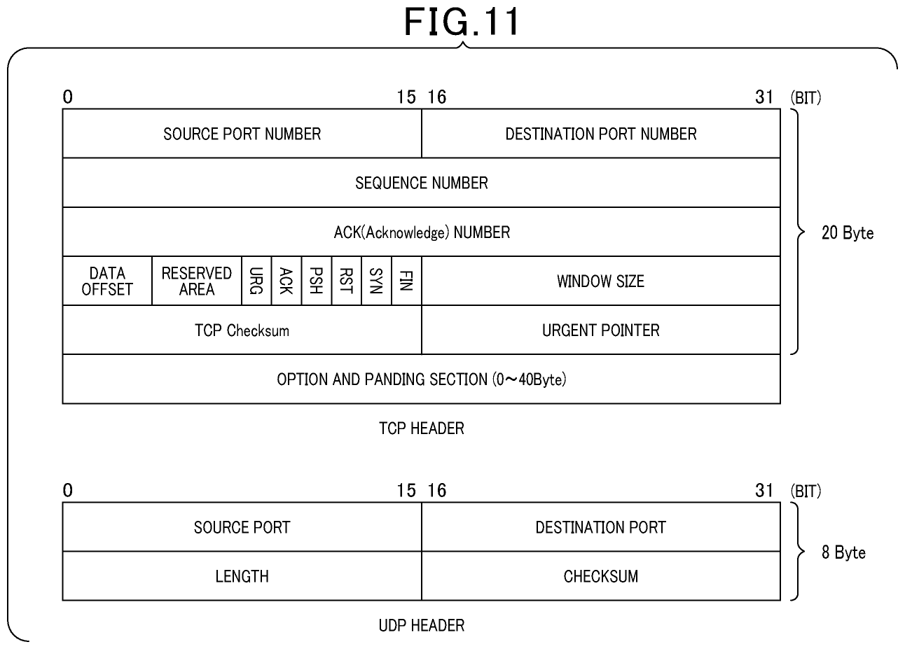

As shown in FIG. 11, the source and destination ports are stored in the TCP and UDP headers, so the source and destination applications can be identified based on them.

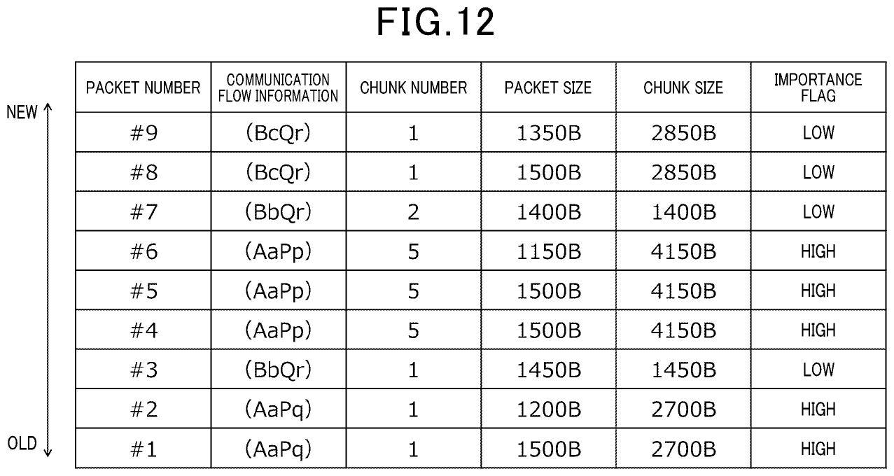

FIG. 12 shows packet information stored in the packet information storage 203. The packet information storage 203 stores communication flow information in addition to the packet information described in the first embodiment, as shown in FIG. 12. The method of expressing the communication flow is as described above.

In addition to the information shown in FIG. 12, the packet information storage 203 may further store the last received time of packets for each flow for the case where chunks of each flow are identified based on the interval of packet reception.

The buffer control unit 205 controls the storing of packets into the buffer 104 and discarding of packets from the buffer 104 for each communication flow based on the chunk to which the packets belong. For example, in FIG. 12, communication flow AaPq and communication flow BbQr are independently controlled to store and discard packets as different chunks even if they have the same chunk number 1. In this embodiment, the chunk to be deleted is selected from the same flow when performing the control described in the Example 1 and the Example 2 of the first embodiment.

According to the second embodiment, in addition to the configuration of the first embodiment, by controlling the storing and discarding of packets into the buffer based on the chunk to which the packets belong for each communication flow, so even when multiple source and destination devices, or multiple source and destination applications are running in a communication device, the possibility of missing data used by each device or application can be reduced, and thus efficient data transmission can be performed.

### 3. Specific Examples of Combinations of Source Device, Communication Device, and Destination Device

Some examples of specific combinations of source device 10, communication device 100 (200), and destination device 20 are described below.

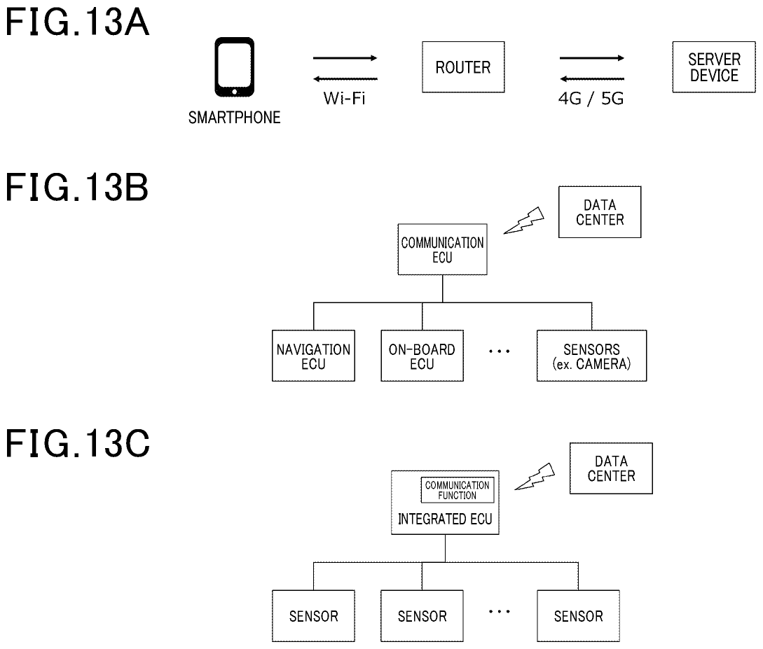

As shown in FIG. 13A, when a video captured by a smartphone is sent to a router via Wi-Fi and uploaded from the router to a server device using a 4G/5G line, the smartphone is the source device 10 (an example of “first device”), the router is the communication device 100 (200), and the server device is the destination device 20 (an example of “second device”). Conversely, when downloading a video from a server device via a router using a 4G/5G line, the server device is the source device 10 (an example of “first device”), the router is the communication device 100 (200), and the smartphone is the destination device 20.

The communication device 100 (200) may be “mounted” to a “mobile object”. as shown in FIG. 13B, when data from ECUs and various sensors connected to the in-vehicle network is transmitted to the data center via a wireless communication method through a communication ECU, the navigation ECU, in-vehicle ECU, and various sensors are the source device 10 (an example of “first device), the communication ECU is the communication device 100 (200), and the data center is the destination device 20 (an example of “second device”). Alternatively, as shown in FIG. 13C, when data from various sensors connected to the in-vehicle network is transmitted to the data center by wireless communication method via the communication function of the integrated ECU, the various sensors are the source devices 10 (an example of “first device”), the integrated ECU is the communication device 100 (200), and the data center is the destination device 20 (an example of “second device”), The integrated ECU is the communication device 100 (200), and the data center is the destination device 20 (an example of the “second device”). The “mobile object” is an object that can move, and the speed at which it moves is arbitrary. It also includes, of course, the case where a mobile object is stationary. Examples include, but are not limited to, automobiles, motorcycles, bicycles, pedestrians, ships, aircraft, and their mountings. The term “mounted” includes cases where the device is directly fixed to a moving object as well as cases where the device is not fixed to a moving object but moves with the moving object. For example, it may be carried by a person on the moving object, or it may be mounted on a load placed on the moving object.

### 4. Summary

The features of the communication devices and other devices in each of the embodiments of this disclosure have been described above. The terms used in each form are examples and may be replaced with terms that are synonymous or include synonymous functions.

The block diagram used to describe the implementation is a classification and organization of the device configuration by function. The blocks that indicate each function are realized by any combination of hardware or software. In addition, since the block diagram shows functions, it can be understood as a disclosure of the invention of a method and a program to realize said method.

The order of the processes, flows, and blocks, which can be understood as methods, described in each form, may be rearranged, as long as there are no restrictions, such as a relationship in which one step uses the results of the other step preceding it.

The communication devices of the present disclosure may be for vehicular applications or include dedicated or general-purpose communication devices other than for vehicular applications, except as specifically limited in the scope of the claims.

Examples of the embodiments of communication devices in this disclosure include semiconductor devices, electronic circuits, modules, and microcomputers. Semi-finished products include electronic control units (ECU (Electric Control Unit)) and system boards. The finished product may take the form of a mobile router, cell phone, smartphone, tablet, personal computer (PC), workstation, or server. Others include devices with communication functions, for example, car navigation systems.

It is contemplated that the communication devices of the present disclosure will be used for the purpose of providing various services. In conjunction with the provision of such services, the communication device of the present disclosure will be used, the method of the present disclosure will be used, and/or the program of the present disclosure will be executed.

In addition, this disclosure can be realized not only with dedicated hardware having the configuration and functions described in each embodiment, but also with a program for realizing this disclosure recorded on a recording medium such as a memory or hard disk, and with general-purpose hardware having a dedicated or general-purpose CPU and memory, etc. capable of executing it. This can also be realized as a combination.

The program for the communication device of this disclosure, which is stored in a non-transitory tangible recording medium (e.g., external storage device (hard disk, USB memory, CD/BD, etc.) or internal storage device (RAM, ROM, etc.)) of dedicated or general-purpose hardware, can be provided via a recording medium or The program can also be provided from the server to dedicated or general-purpose hardware via communication path without the need for the server. This allows the latest functions to be constantly provided through program upgrades.

Industrial applicability: The communication devices of this disclosure can be used for both automotive and non-automotive applications. Furthermore, it can also be applied to relay devices.

What is claimed is:

1. A communication device that transmits packets received from a first device to a second device using one of a plurality of communication lines, the communication device comprising:
a receiver that receives packets from the first device;
a packet identification unit that identifies a chunk, which is a data unit in upper layers, to which the packets belong;
a buffer that stores the packets;
a buffer control unit that controls storing the packets into the buffer and discarding the packets from the buffer based on the chunk to which the packets belong; and
a transmitter that reads the packets from the buffer and transmits the read packets to a second device,
wherein the buffer control unit discards, based on whether a first packet received by the receiver can be stored into the buffer and based on the chunk to which the first packet belongs, a second packet which is a stored packet in the buffer and other packets in the buffer, the second packet and the other packets belonging to the first chunk or a second chunk.

2. The communication device according to claim 1,
wherein the packet identification unit identifies the chunk based on the reception interval of the packets received by the receiver.

3. The communication device according to claim 1,
wherein the chunks are frames generated by compression of video.

4. The communication device according to claim 1,
wherein the packet identification unit identifies the chunk based on the identifier contained in the IP header of the packet.

5. The communication device according to claim 1,
wherein the packet identification unit identifies the chunk based on the TCP/UDP payload of the packet.

6. The communication device according to claim 1,
wherein the buffer control unit, when the first packet cannot be stored into the buffer due to exceeding a capacity of the buffer, discards the packets including the second packet and belonging to a second chunk which is different from a first chunk to which the first packet belongs.

7. The communication device according to claim 1,
wherein the buffer control unit, when the first packet cannot be stored into the buffer due to exceeding a capacity of the buffer, discards the packets including the second packet and belonging to a second chunk which is different from a first chunk to which the first packet belongs and stored into the buffer earliest in time.

8. The communication device according to claim 1,
wherein the buffer control unit, when the first packet has been stored into the buffer, discards the packets including the second packet and belonging to a second chunk which is different from a first chunk to which the first packet belongs and stored into the buffer earlier than the first packet.

9. The communication device according to claim 1,
wherein the buffer control unit, when the first packet has been stored into the buffer, discards the packets including the second packet and belonging to a second chunk which is different from a first chunk to which the first packet belongs and stored into the buffer earliest in time.

10. The communication device according to claim 6,
wherein the buffer control unit, when the packets stored in the buffer and belonging to the second chunk exceed a predetermined ratio of all the packets belonging to the second chunk, discards the packets belonging to the second chunk.

11. The communication device according to claim 10,
wherein the transmitter, when the packets stored in the buffer and belonging to the second chunk exceed a predetermined ratio of all the packets belonging to the second chunk, stops transmitting the packets stored in the buffer and belonging to the second chunk.

12. The communication device according to claim 6,
wherein the buffer control unit, when the importance level of the second packet exceeds the predetermined importance level, does not discard the packets including the second packet and belonging to the second chunk.

13. The communication device according to claim 12,
wherein the buffer control unit, when the importance level of the first packet exceeds the predetermined importance level, discards the packets including the second packet and belonging to the second chunk regardless of the importance level of the second packet.

14. The communication device according to claim 1,
wherein the buffer control unit, when the first packet cannot be stored into the buffer due to exceeding the capacity of the buffer, discards the second packet belonging to the first chunk.

15. The communication device according to claim 1,
wherein the packet identification unit identifies communication flow to which the packets belong, and
the buffer control unit controls storing the packets into the buffer and discarding the packets from based on the communication flow to which the packets belong.

16. The communication device according to claim 1,
wherein the communication device is mounted to a mobile object.

17. A communication method using a communication device that transmits packets received from a first device to a second device using one of a plurality of communication lines, the method comprising:
receiving packets from the first device;
identifying a chunk, which is a data unit in the upper layers, to which the packets belong;
controlling storing the packets into a buffer and discarding the packets from the buffer based on the chunk to which the packets belong; and
reading the packets from the buffer and transmitting the read packets to a second device,
wherein the controlling includes discarding, based on whether a first packet received by the receiver can be stored into the buffer and based on the chunk to which the first packet belongs, a second packet which is a stored packet in the buffer and other packets in the buffer, the second packet and the other packets belonging to the first chunk or a second chunk.

18. A computer-readable non-transitory storage medium storing a program, the program causing a communication device that transmits packets received from a first device to a second device using one of a plurality of communication lines to:
receive packets from the first device;
identify a chunk, which is a data unit in the upper layers, to which the packets belong;
control storing the packets into a buffer and discarding the packets from the buffer based on the chunk to which the packets belong; and
read the packets from the buffer and transmit the read packets to a second device,
wherein the controlling includes discarding, based on whether a first packet received by the receiver can be stored into the buffer and based on the chunk to which the first packet belongs, a second packet which is a stored packet in the buffer and other packets in the buffer, the second packet and the other packets belonging to the first chunk or a second chunk.
